(19) United States
(12) Patent Application Publication
(10) Pub. No.: US 2021/0264366 A1
(43) Pub. Date: Aug. 26, 2021

(54) SMART CONTENT CREATION FOR E-COMMERCE

(71) Applicant: Ariel Scientific Innovations Ltd., Ariel (IL)

(72) Inventors: Roman YAVICH, Netanya (IL); Vladimir ROTKIN, Haifa (IL); Sergey MALEV, Haifa (IL); Eliahu ZAMIR, Neve Ilan (IL); Or KADRAWI, Shvut Rachel (IL)

(73) Assignee: Ariel Scientific Innovations Ltd., Ariel (IL)

(21) Appl. No.: 17/183,435

(22) Filed: Feb. 24, 2021

Related U.S. Application Data
(60) Provisional application No. 62/980,460, filed on Feb. 24, 2020.

(51) Int. Cl. G06Q 10/10; G06Q 30/06; G06Q 50/14; G06F 30/10; G06F 16/2457; G06F 16/22

(52) U.S. Cl. CPC G06Q 10/101; G06Q 30/0631; G06Q 50/14; G06Q 30/0203; G06F 16/2457; G06F 16/2246; G06F 30/10

(57) ABSTRACT

A method for producing parameters for product design. The method comprises receiving explicit or implicit preferences, directly or indirectly, from customers, and constrains from at least one provider. The method includes mapping the preferences and constraints to a space, where searches for an optimum are limited according to the constraint. The parameters for product design are produced according to at least one optimum found. The method may be performed by a system which comprises at least one processor adapted to execute code and at least one memory storing a preference data structure, designed in accordance with the space.

### RELATED APPLICATION(S)

This application claims the benefit of priority under 35 USC § 119(e) of U.S. Provisional Patent Application No. 62/980,460 filed on Feb. 24, 2020, the contents of which are incorporated by reference as if fully set forth herein in their entirety.

### FIELD AND BACKGROUND OF THE INVENTION

The present invention, in some embodiments thereof, relates to automatic product design, and, more particularly, but not exclusively, design of tourism products for a plurality of people.

Products nowadays are designed by field experts, often using computer aided design (CAD) tools, however making the decisions manually. Marketing professionals often invest a lot of time, effort and money in conducting focus groups among customers. Preferences are often subconscious or conceived implicitly, and difficult to verbalize or express explicitly in many circumstances. Consequently, for example, travel agencies offer a few tour packages for a destination country, visiting substantially the same attractions. Additionally, electric products such as ovens and are designed to accommodate markets, with few option to meet specific preferences.

### SUMMARY OF THE INVENTION

The present invention, in some embodiments thereof, relates to automatic product design, and, more particularly, but not exclusively, design of tourism products for a plurality of people.

According to a first aspect of some embodiments of the present invention there is provided a system for producing parameters for product design, the system comprising one or more memories storing one or more preference data structures and a code, and a processor adapted to execute the code for:
Receiving a plurality of preferences parameters of a plurality of customers.
Receiving one or more constraints from one or more providers.
Mapping one or more preference parameters from the plurality of preferences parameters of the plurality of customers to the preference data structure, wherein one or more dimensions of the preference data structure is associated with one or more of the parameters for product design, and elements are associated with one or more of the preferences parameters associated with the one or more of the parameters for product design.
Mapping the one or more constraint to a geometric constraint derived from a geometry defined by the preference data structure geometry.
Finding one or more optimum based on elements in accordance with the geometric constraint on the preference data structure, wherein the space searched for the one or more optimum is limited according to the geometric constraint.
Producing one or more parameters for product designs in accordance with the one or more optimums.

According to a second aspect of some embodiments of the present invention there is provided a computer implemented method for producing a product design comprising:
Receiving a plurality of preferences parameters of a plurality of customers.
Receiving one or more constraints from one or more providers.
mapping one or more preference parameters from the plurality of preferences parameters of the plurality of customers to the preference data structure, wherein one or more dimensions of the preference data structure is associated with one or more of the parameters for product design.
Mapping the one or more constraints to a geometric constraint derived from a geometry defined by the preference data structure geometry.
Finding one or more optimums in accordance with the geometric constraint on the preference data structure, wherein the space searched for the one or more optimums is limited according to the geometric constraint.
Producing one or more parameters for product designs in accordance with the one or more optimums.

According to a third aspect of some embodiments of the present invention there is provided a computer readable medium storing program instructions for producing a product design comprising:
Receiving a plurality of preference parameters of a plurality of customers.
Receiving one or more constraints from one or more providers.
mapping one or more preference parameters from the plurality of preferences parameters of the plurality of customers to the preference data structure, wherein one or more dimensions of the preference data structure is associated with one or more of the parameters for product design.
Mapping the one or more constraints to a geometric constraint derived from a geometry defined by the preference data structure geometry.
Finding one or more optimums in accordance with the geometric constraint on the preference data structure, wherein the space searched for the one or more optimums is limited according to the geometric constraint.
Producing one or more parameters for product designs in accordance with the one or more optimum.

In a further implementation form of the first, second and/or third aspects, there is further provided finding one or more optimums comprises calculating at least a partial cumulative sum data structure of elements of the preference data structure.

In a further implementation form of the first, second and/or third aspects, one or more of the parameters for product design are associated with a geometrical location, and one or more geometric constraints is of length in one or more of the dimensions of the preference data structure, the dimension associated with geometrical distance.

In a further implementation form of the first, second and/or third aspects, one or more of the parameters for product design is associated with a physical property of a physical object, and one or more geometric constraints in one or more of the dimensions of the preference data structure, the dimension associated with manufacturability constraints.

In a further implementation form of the first, second and/or third aspects, there is further provided generating a plurality of parameter sets for product designs, and rendering a plurality of images of a plurality of product in associative accordance with the plurality of parameter sets.

In a further implementation form of the first, second and/or third aspects, there is further provided receiving a preference score from one or more customers associated with one or more of the plurality of images.

In a further implementation form of the first, second and/or third aspects, there is further provided updating one or more entry values in the preference data structure according to the received preference score.

In a further implementation form of the first, second and/or third aspects, one or more of the parameters for product design is derived from factorization of products associated with the parameters for product design.

In a further implementation form of the first, second and/or third aspects, one or more of the plurality of customers is selected by a recommender system, wherein one or more parameters are associated with the one or more of the plurality of customers, meets a matching criteria associated with the preference data structure.

In a further implementation form of the first, second and/or third aspects, one or more of the plurality of preferences parameters is associated with a collaborative filtering system, wherein one or more parameters associated with the one or more of the plurality of customers, meets a matching criteria associated with the preference data structure.

In a further implementation form of the first, second and/or third aspects, the preference data structure is mapped to a tensor.

In a further implementation form of the first, second and/or third aspects, the preference data structure is mapped to a k-d tree.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings, maps, and pseudocode. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system for automatic product design, according to some embodiments of the present invention;

FIG. 2 is a flow chart of an exemplary process for automatic product design, according to some embodiments of the present invention;

FIG. 3 is a flow chart of another exemplary process for automatic product design, according to some embodiments of the present invention;

FIG. 4 is a diagram for an exemplary computer implemented method for automatic product design, according to some embodiments of the present invention;

FIG. 5 is another diagram for an exemplary computer implemented method for automatic product design, according to some embodiments of the present invention;

FIG. 6 depicts an exemplary graphic user interface for receiving preferences by a system for automatic product design, according to some embodiments of the present invention;

FIG. 7 depicts an exemplary sequence of updating parameters for product design, according to some embodiments of the present invention;

FIG. 8A is a map of London, annotated with location of tourist attractions, according to some embodiments of the present invention;

FIG. 8B is a rectangular area marker generated by process for automatic product design, according to some embodiments of the present invention;

FIG. 8C is an exemplary tour bus schedule, according to some embodiments of the present invention;

FIG. 9A depicts some exemplary parameters of a vase, according to some embodiments of the present invention;

FIG. 9B depicts some exemplary drawings for rendered vase designs, generated according to parameters set by a system for automatic product design, according to some embodiments of the present invention; and

FIG. 10 is a pseudocode for an exemplary computer implemented algorithm for parametric optimum finding, according to some embodiments of the present invention.

### DESCRIPTION OF SPECIFIC EMBODIMENTS OF THE INVENTION

The present invention, in some embodiments thereof, relates to automatic product design, and, more particularly, but not exclusively, design of tourism products for a plurality of people.

Shortcomings of this known practice include limited selection of products in most categories, and inability to personalize many products to meet individual needs or needs of smaller population groups.

Some embodiments of the present invention involve collecting preferences from a group of customers. This group might be self-organized, a consumer club, an organization, a group of clients formed automatically using systems such as recommender systems or clustering of a larger group, and/or the likes. The preferences may be obtained by questionnaire filling, or by automatic inference from personal information collected such as location, web site visits, web search queries submitted, purchases made, and/or the likes.

Some embodiments of the present invention involve mapping potential products to a multi-dimensional space, or namely factorization. Some of these embodiments comprise quantizing the multi-dimensional space to a data structure, wherein elements of the data structure correspond to a parameter set, defining properties of associated potential products. The data structure may be a graph, for example a k-d tree, a tensor, for example a matrix, and/or the likes. The values, or scores, are allocated to its elements in accordance to preferences of the customers. Some of these embodiment comprise calculating data structures of cumulative summations of the allocated scores of the score data structure. Some of these embodiment comprise using the cumulative summation data structure for searching for optimal or near optimal solutions in accordance with supplier constraints.

Some embodiments of the present invention may comprise an interactive, semi-automatic search in the multi-dimensional space, for a preferred product. For example, abroad range of vases may be characterized by factors. Some of these factors may be semantically meaningful. For example, base width, top opening width, opening height, presence and dimensions of a spheroid in the center, whether the horizontal cut is circular, cogwheel, or flower like, and/or the likes. However, some of these factors may be hard to associate with a verbal description. An optimization process may comprise several iteration of rendering one or more vases, while fixing one or more of these factors, and randomizing one or more of the other factors. The user may rate one or more of these vases, producing cues associated with personal preferences.

Some embodiments of the present invention may comprise forming a list of local and/or near optima. For example, producing a plan for different days in tour packages, may allocate one day to an optimum, and another day to a secondary optimum. An exemplary three day museum trip to London may focus one day on London bridge area, the next day on Westminster area, the third day on Kensington.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

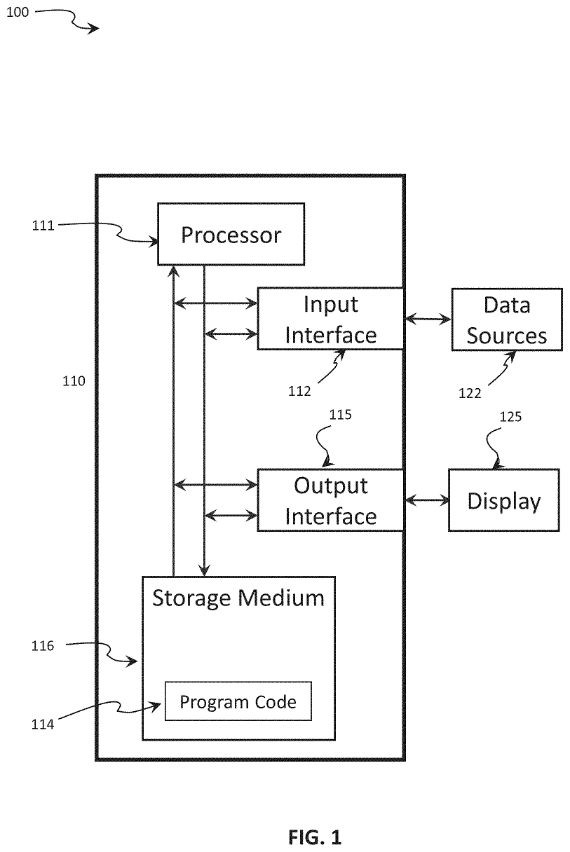

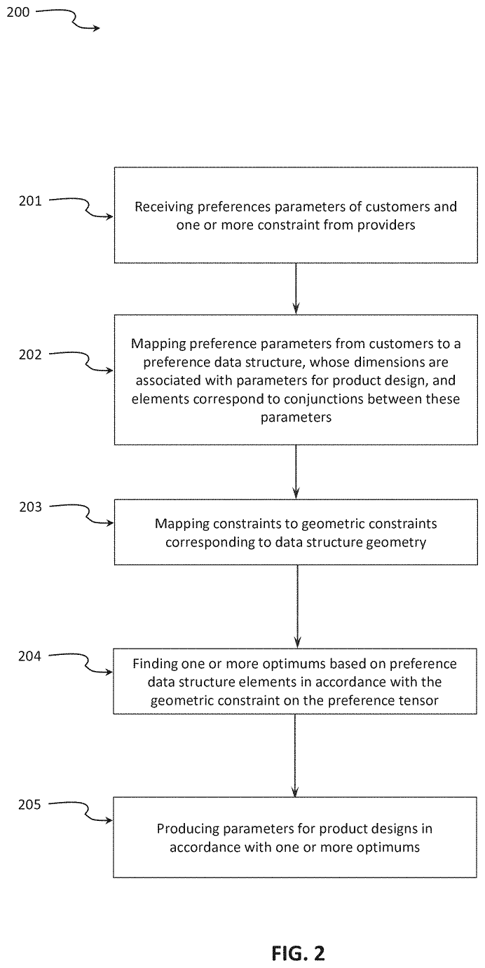

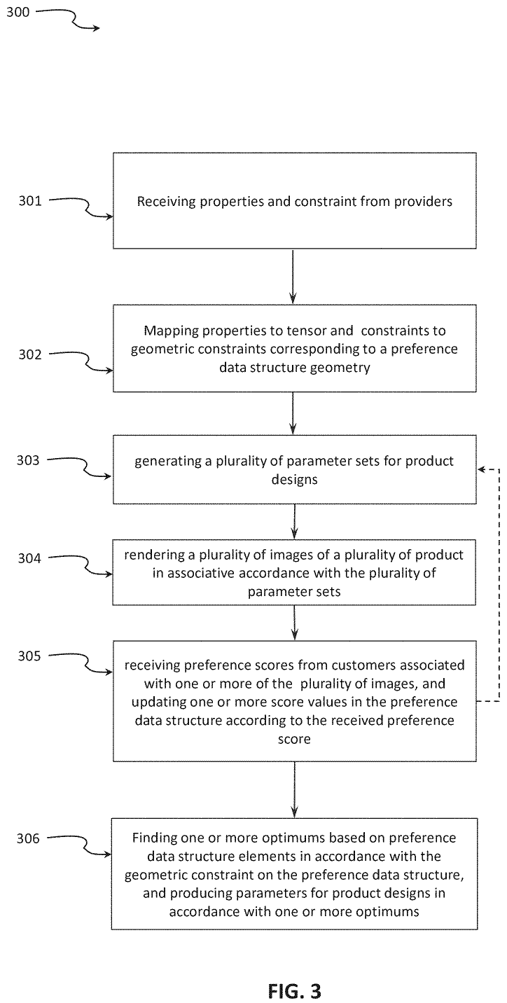

Referring now to the drawings, FIG. 1 is a schematic illustration of an exemplary system for automatic product design, according to some embodiments of the present invention. An exemplary system for automatic product design 100 may execute processes such as 200 and/or 300 for automatic product design. Further details about these exemplary processes follow as FIG. 2 and FIG. 3 are described.

The system 110 may include an input interface 112, an output interface 115, one or more processors 111 for executing processes such as 200 and/or 300, and storage 116 for storing code (program code storage 114) and/or data. The system may be physically located on a site, implemented on a mobile device, implemented as distributed system, implemented virtually on a cloud service, on machines also used for other functions, and/or by several options. Alternatively, the system, or parts thereof, may be implemented on dedicated hardware, FPGA and/or the likes. Further alternatively, the system, or parts thereof, may be implemented on a server, a computer farm, the cloud, and/or the likes.

The input interface 112, and the output interface 115 may comprise one or more wired and/or wireless network interfaces for connecting to one or more networks, for example, a local area network (LAN), a wide area network (WAN), a metropolitan area network, a cellular network, the internet and/or the like. The input interface 112, and the output interface 115 may further include one or more wired and/or wireless interconnection interfaces, for example, a universal serial bus (USB) interface, a serial port, a controller area network (CAN) bus interface and/or the like. Furthermore, the output interface 115 may include one or more wireless interfaces, and the input interface 112, may include one or more wireless interfaces for receiving information from one or more devices. Furthermore, the input interface may comprise interface with the internet, computer readable media, and input devices such as one or more cameras, microphones, touch screens, keyboards, and/or the like. Additionally, the input interface 112 may include specific means for communication with one or more data sources 122 to receive data as records from an agency, datasets from established e-commerce companies, data filtered by a recommender system, collaborative filtering and/or the likes. And similarly, the output interface 115 may include specific means for communication with service providers, manufacturing facilities and/or machinery, and/or one or more display devices 125 such as printers, screens, and/or the like.

The one or more processors 111, homogenous or heterogeneous, may include one or more processing nodes arranged for parallel processing, as clusters and/or as one or more multi core one or more processors. The storage 116 may include one or more non-transitory persistent storage devices, for example, a hard drive, a Flash array and/or the like. The storage 116 may also include one or more volatile devices, for example, a random access memory (RAM) component and/or the like. The storage 116 may further include one or more network storage resources, for example, a storage server, a network attached storage (NAS), a network drive, and/or the like accessible via one or more networks through the input interface 112, and the output interface 115.

The one or more processors 111 may execute one or more software modules such as, for example, a process, a script, an application, an agent, a utility, a tool, an operating system (OS) and/or the like each comprising a plurality of program instructions stored in a non-transitory medium within the program code 114, which may reside on the storage medium 116. For example, the one or more processors 111 may execute a process, comprising automatic product design such as or as 200, 300 and/or the like. This processor may generate instructions, blueprints, plans, parameters and/or the like.

Reference is also made to FIG. 2 which is a basic flow chart of a first exemplary process for automatic product design, according to some embodiments of the present invention. The process 200 may be executed by the one or more processors 111.

The process 200 may start, as shown in 201 by Receiving preferences parameters of customers and one or more constraint from providers through the input interface 112. The preference parameters may be explicitly related to a property of a product, such as width, height, number of handles, and/or the likes, or implicit, tacit properties which may be impractical to describe verbally. The preference may be a binary indication of a desired configuration, a range of preference, a priority rating, and/or the likes. The process 200 may take the preference as they are, however some adjustments and tuning for bias correction, or other heuristics may be applied. The customers may be occasional potential buyers, organized by a club, recommended by an e-commerce system, member or employees of an organization, and/or the likes.

The constrains from a provider may be of dimensions, shapes, materials, colors, and/or the likes, and may be derived from costs, machinery limitations, transportation ability, time constraints, quantity, and or the likes. Furthermore, the constraints may relate to timing, delivery location, and/or the likes. The provider may be a manufacturer, a travel agent, a reseller, and/or the likes. The preferences and constraints may be received when a customer and/or a provider registers to a service associated with smart content creation, on occasion such as a month before a holiday, and/or the likes. The preferences and constraints may be received automatically through the internet, through computer readable media, typed manually, scanned, and/or the likes.

The processor may also execute Mapping preference parameters from customers to a preference data structure, whose dimensions are associated with parameters for product design, and elements correspond to conjunctions between these parameters during execution of 202.

As used herein, the term “data structure” may refer to one or more vectors, matrices, higher dimension tensors, graph representation such as directed graphs, k-d trees, sparse representations, lists, textual representations such as xml or json files, and other practically interchangeable data structures.

As used herein, the terms “element”, “nodes”, “vertices” are used interchangeably, and should be construed to comprise data elements within a data structure. These elements may comprise one or more integers, floating point numbers, characters, words, symbols, and/or the likes.

As used herein, the terms “values” and “scores” are used interchangeably, and should be construed to refer to a numerical or a practically interchangeable value. The parameters of the preference data structure may be considered a latent space describing a subset of the potential product. Some parameters may still be explicitly related to a property of a product, such as size, smoothness, and or the likes, however some other parameters may describe implicit properties which may be impractical to describe verbally.

The preferences associated with one or more parameters may be mapped a to a preference data structure. For example, when the preference data structure comprises a matrix representing geographic locations, a preference may increase the value of an element whose location within the matrix corresponds to that preference. Alternatively, when the preference data structure comprises a k-d tree, a value at a corresponding leaf node may be increased.

Furthermore, as shown in 203, the process 200 may continue by mapping constraints to geometric constraints corresponding to data structure geometry.

In some examples, a number of points or ranges of elements can be manufactured, for instance, products may be limited to 3 different set sizes, or a limited size range. Furthermore, a constraint may associated with angles, ratios, weights, circularity or deviation from circularity, materials, colors, thickness, elasticity, and/or the likes. Alternatively, a constraint may be associated with geographic locations, distances from other geographic location, scales of timing such as week day, daily hours, seasons, and/or the likes. Optionally, the constraints may impose limitation on a plurality of constraints, dependently or independently.

Additionally, as shown in 204, the process 200 may continue by finding one or more optimums based on preference data structure elements in accordance with the geometric constraint on the preference tensor. These optimums represent parameter configurations meeting many customer preferences.

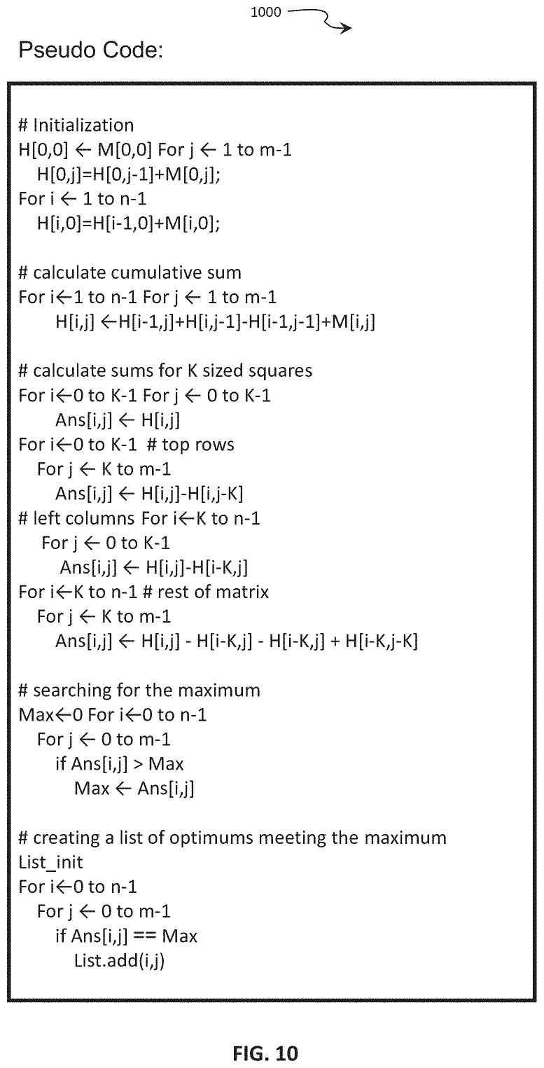

The optimum may be a maximal number of preference indicators, based on customer preference covered by potential choices compliant with the constraints. Optionally, straightforward greedy algorithms may be sufficient to find the optimum. Alternatively, an extensive variety of optimization methods, such as hierarchical or multi resolution algorithms can be used. Furthermore, cumulative summation based algorithms may be applied, and more details about an exemplary cumulative summation based algorithm are in FIG. 10.

Subsequently, as shown in 205 the process 200 continues by producing parameters for product designs in accordance with one or more optimums and delivered through the output interface 115. The parameters may be produced and delivered to one or more provider as numbers, instructions for manual work, drawings, blueprints, automatic instruction for machinery, graphical visualizations such as areas over maps, and/or the likes. These parameters may be used to produce tangible products such as furniture, vases, boxes, electric products such as ovens, refrigerators, electric shavers, and/or the likes, while meeting customer preferences. Furthermore, intangible products such as tourism travel packages, parties, sport classes, and/or the likes may be created in accordance with these parameters. These parameters may be delivered as printed media,

Reference is also made to FIG. 3, which is a basic flow chart of another exemplary process for automatic product design, according to some embodiments of the present invention.

The exemplary process 300 may be executed, for example, when user preferences are harder to conceive verbally. Aesthetic preferences, for example, are hard to define lexically. Preferences for a decorative vase are a further specific example for aesthetic preferences. It should be noted that the process 300 may be used for all kinds of preferences and not limited to aesthetics. The process 300 may be executed by the one or more processors 111.

The process 300 may start, as shown in 301 by receiving a plurality of properties and constraint from a provider through the input interface 112. Similarly to 201, the constrains from a provider may be of dimensions, shapes, materials, colors, and/or the likes, and may be derived from costs, machinery limitations, transportation ability, time constraints, quantity, and/or the likes. Furthermore, the constraints may relate to timing, delivery location, and/or the likes. The provider may be a manufacturer, a travel agent, a reseller, and/or the likes.

The processor 111 may further execute, as shown in 302, mapping properties to tensor and constraints to geometric constraints corresponding to data structure geometry.

The geometry of the preference data structure may be considered a latent space describing a subset of the potential product. Axes and/or edges of the preference data structure may be associated with properties which are meaningful in manufacturing context, however tricky to explain to customers, such as materials, timing of manufacture stages, complex geometric relations, and/or the likes. Additionally and alternatively, axes and/or edges of the preference data structure may relate to more straightforward properties such as weight, color, and/or the likes. The mapping of the constraints may be executed similarly to 203, as described in FIG. 2's description.

The process 300 may continue, as shown in 303, by generating a plurality of parameter sets for product designs. The parameter sets comprise parameters associated with the preference data structure. Optionally, one or more of the parameters may be fixed to a value previously decided or calculated, and generate a variety of values for one or more other parameters. For example, parameter sets fixing the handle color, however varying the base color of a cup may be generated.

The process 300 may further continue, as shown in 304, rendering a plurality of images of a plurality of product in associative accordance with the plurality of parameter sets. The images may be shown as drawings, or rendered in conditions representing their expected appearance as used by a customer, as would appear on display at a store, in outdoor sunlight, in a dimly lit room, and/or the likes. The images may be rendered from a variety of viewpoints and over different backgrounds. Optionally rendering may be personalized to reviewer preferences. These images may be displayed as shown in 125 on a screen, by a projector, or the likes. One or more customers, designers, focus group participants, artists, experts, and/or the likes may review the images and express their preference.

The process 300 may continue, as shown in 305, by receiving preference scores, as expressed in 304, through the input interface 112. These preferences may be received from reviewers such as customers, and associated with one or more of the plurality of images. The processor may update one or more score values in the preference data structure according to the received preference score. For example, the value corresponding to a preferred parameter sets may be increased. Optionally, images may be rated and the values corresponding to high rated parameter sets may be increased, while the values corresponding to low rated parameter sets may be decreased.

The process 300 may comprise several repetitions of steps 303, 304, and 305, optionally with a different choice of fixed parameters and varied parameter. Optionally, preferences represented in the preference data structure may be used to guide the selection of the new parameter sets.

And subsequently, as shown in 306, the process 300 may continue by Finding one or more optimums based on preference data structure elements in accordance with the geometric constraint on the preference data structure, and producing parameters for product designs in accordance with one or more optimums. The finding of the optimums may be executed similarly to 204, and the producing of the parameters may be executed similarly to 205, as described in FIG. 2's description.

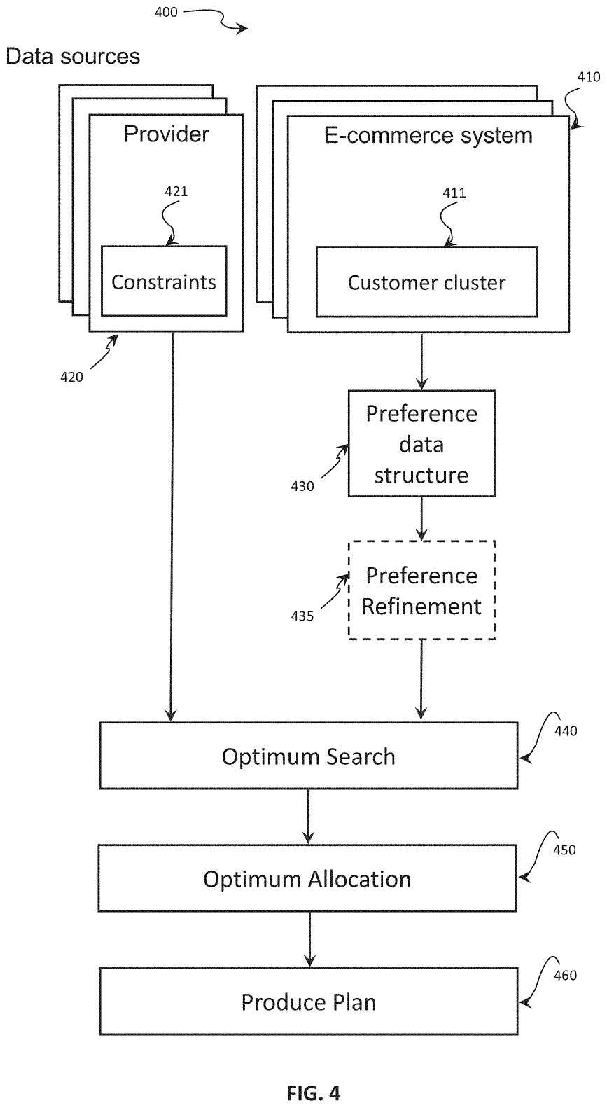

Reference is now made to FIG. 4 which is a diagram for an exemplary computer implemented method for automatic product design, according to some embodiments of the present invention. The system for automatic product design may have interface with an e-commerce system, a system for customer selection such as an e-commerce system 410, which may comprise recommender system, collaborative filtering and/or the likes. The system may be operated by the agent applying the method for automatic product design, by a customer, a provider, and/or by a third party. A cluster of customers 411 with associated preferences may be introduced through the input interface 112.

The provider 420, may introduce the constraints 421. The constrains may be hard manufacturing constraints, or softer, cost effectiveness constraints such as timings and/or locations benefitting form off peak time discounts. Furthermore, constraints may comprise dimensions, shapes, materials, colors, and/or the likes. The preferences introduced may be mapped to the preference data structure 430. The mapping may be executed similarly to 302, as described in FIG. 3's description. Optionally, some heuristics, or a process such as 300 may be executed to refine the preferences as shown in 435. The refinement may be used to meet condition for optimization algorithms best modes, or to compensate for known research biases such as priming or social acceptance.

In 440 one or more optimums may be found. Various optimization methods can be applied to find the configuration compliant with the constraints that maximises the preferences met. Gradient methods, and greedy algorithms may be used. Some algorithms may not guarantee finding the true, global optimum, and some other algorithms may be impractical due to memory and/or processing time required, due to their complexity. More details about an algorithm which applies the constraint structure to reduce the complexity are in FIG. 10's description.

In 450 one or more optimums may be allocated. Optionally more than one optimums may be included in the product design. For example, a plan for a trip to London may comprise more than one day for visiting museums in a certain vicinity. The algorithm may search for further optimums, and non-maximum suppression (NMS) may be used to increase variety.

And in 460 the product design plan may be produced according to one or more optimums found in 450. The plan may be delivered through the output interface 115, to one or more of the providers, customers, and/or a third party, to enable strong matching between the plan and the customer preferences.

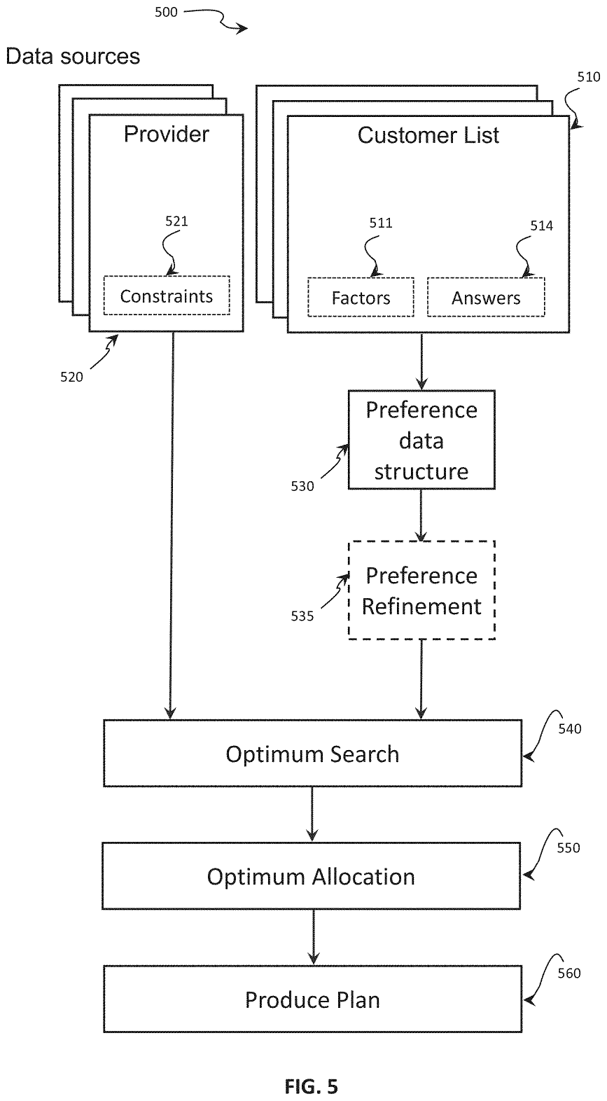

Reference is also made to FIG. 5 which is another diagram for an exemplary computer implemented method for automatic product design, according to some embodiments of the present invention.

The system for automatic product design may be applied on a customer list 510, comprising a list of customers 511, and associated answers 514. The answers may be collected explicitly through manual or automated questionnaires, through automatically collected data such as web history, and/or the likes. The list may be introduced through the input interface 112.

The provider 520, may introduce the constraints 521. The preferences introduced, optionally together with further query answers, may be mapped to the preference data structure 530. The mapping may be executed similarly to 302, as described in FIG. 3's description. Optionally, some heuristics, or a process such as 300 may be executed to refine the preferences as shown in 535.

In 540 one or more optimums may be found. The optimums may be found similarly to 440 as described in FIG. 4's description. In 550 one or more optimums may be allocated. The optimums may be allocated similarly to 450 as described in FIG. 4's description.

And in 560 the product design plan may be produced according to one or more optimums found in 550. The plan may be delivered to one or more of the providers, customers, and/or a third party.

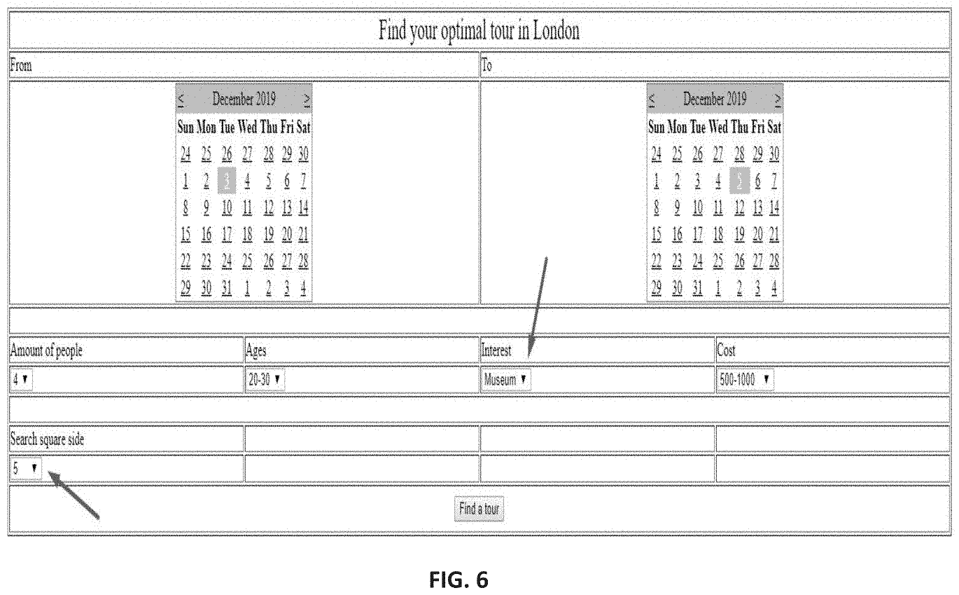

Reference is now made to FIG. 6 which depicts an exemplary graphic user interface for receiving preferences by a system for automatic product design, according to some embodiments of the present invention. The graphic user interface comprises a staring day, ending day, how many people are in the group, the age range, the interest, the budget, and the constraint is the area that may be covered on a day trip, by a square size. The starting and ending days may be rigid or within tolerance, and may be used to check relevant opening hours, and determine the number of days to optimize areas for. Parameters such as age range, budget, and interests may be further use to refine scores allocated in accordance with matching attractions.

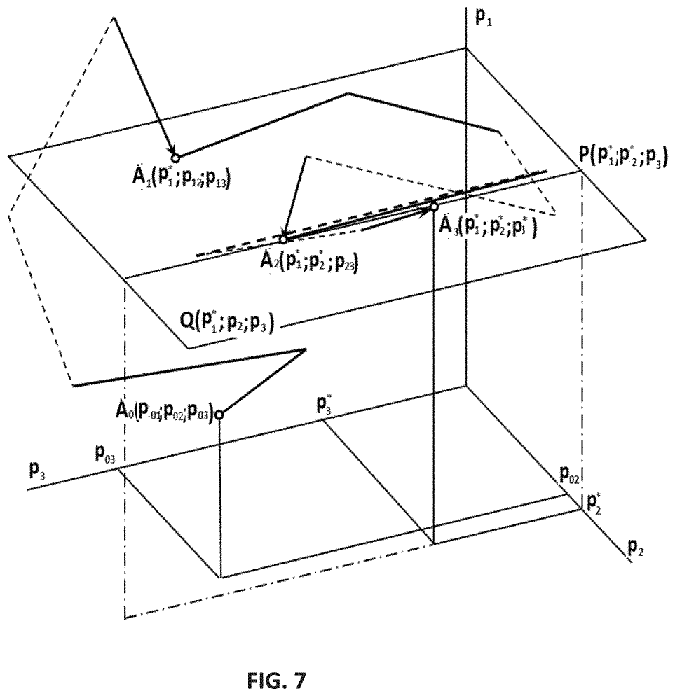

Reference is also made to FIG. 7 depicts an exemplary sequence of updating parameters for product design, according to some embodiments of the present invention;

In this example, the product parameters are mapped to a three dimensional space, A search, where pone parameter is fixed, and two other varies, starts at the parameter set A₀, which comprises the parameter P₀₁, P₀₂, and Poi. In the first step P₁ is fixed. This step is followed by other 4 such steps, where other parameters may be fixed. The parameter set A₁, which comprises the parameter P₁₁, P₁₂, and P₁₃, is reached after this step, and the process continues with 5 such steps before reaching the parameter set A₂, and two additional such steps to the parameter set A₃. The parameter update may be random, or may be chosen in accordance to preference queries of reviewers.

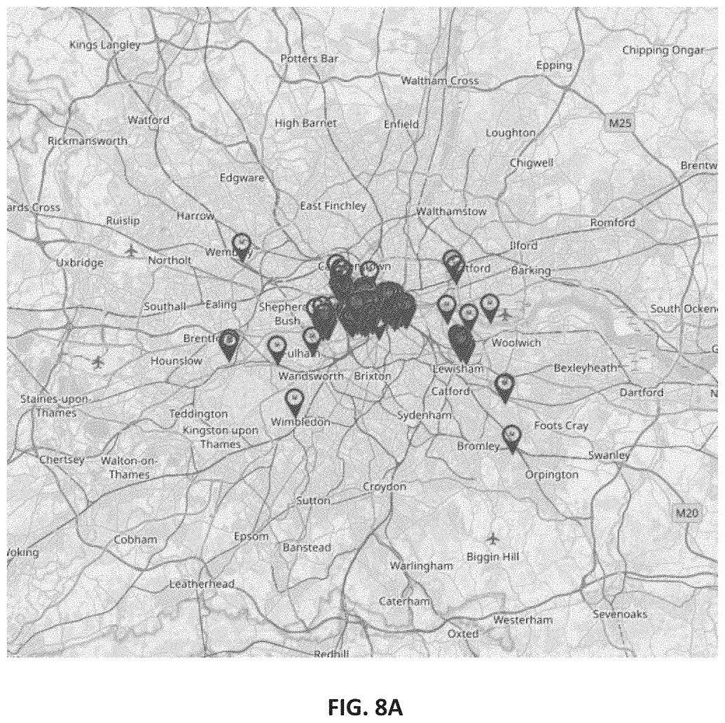

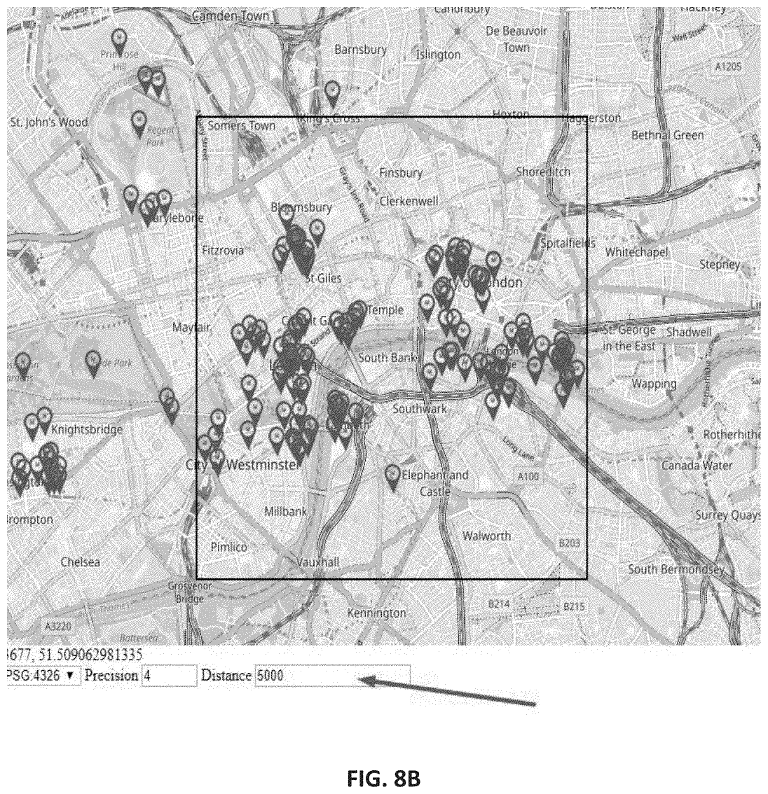

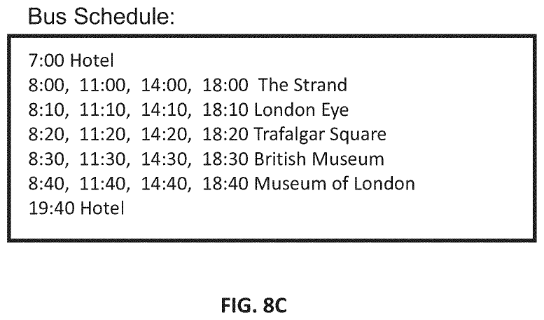

Attention is drawn to FIG. 8A is a map of London, annotated with location of tourist attractions, according to some embodiments of the present invention. In this example the preference score assigned to each attraction shown, for example the museums, is equal. Optionally, the data structure may be a matrix, each element assigned to a square area of a fixed size, and the value of the element may be the number of museums located within the square area.

Reference is made to FIG. 8B where a rectangular area marker generated by process for automatic product design, according to some embodiments of the present invention. The area was selected according to the constraint of a square area whose sides are 5 kilometers long, maximizing the number of museums found in the area with accordance to the exemplary preferences shown in the graphic user interface in FIG. 6.

Reference is also made to FIG. 8C which is an exemplary tour bus schedule, according to some embodiments of the present invention. This exemplary schedule may be generated by further clustering the points of interests within the square area found and shown in FIG. 8B. Alternatively, it may comprise some manual work, and/or one or more choices from a pre-made list of potential stops. The bus may serve a group hosted in a hotel in the outskirts of London, and provide a trip from and to the hotel, as well as four daily shuttles between the five stops, which are located in museum clusters. Alternatively, the bus may visit a stop, and return to that point after some time, in order to take the group to the next stop. It should be noted that other plans may be produced based on the square area found, and different constrains and different scenarios may apply. For example, in destinations where a ferry service is required to cross a river or move between islands, the schedule of the ferry may be a constraint.

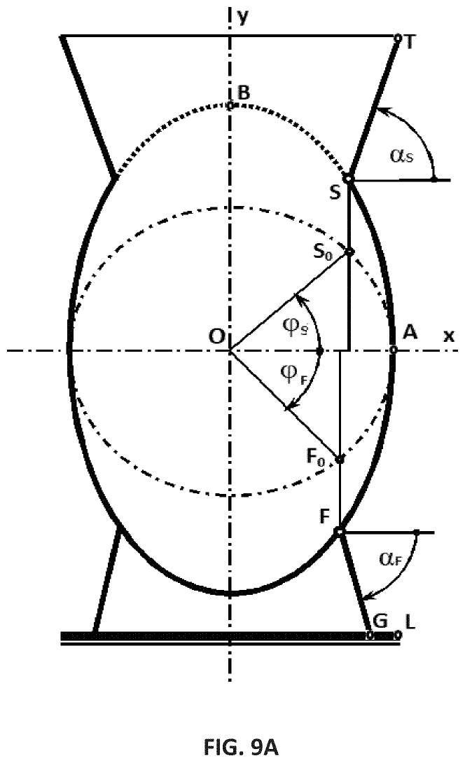

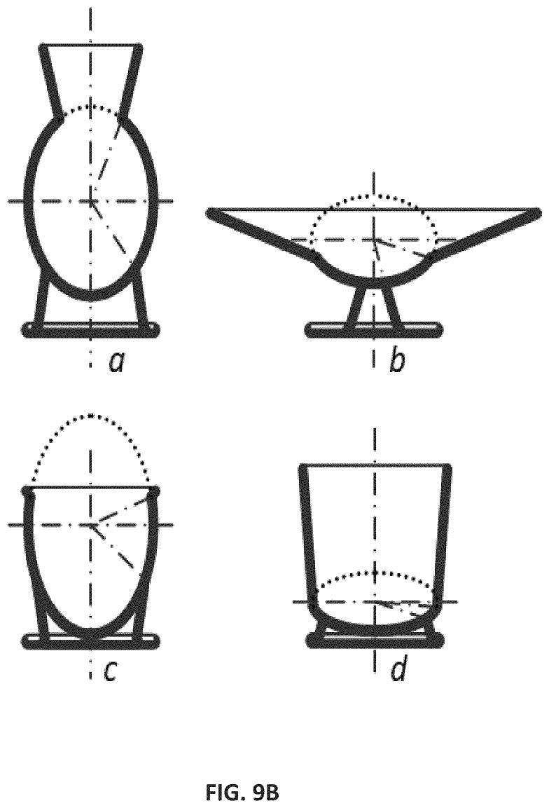

Reference is now made to FIG. 9A which depicts some exemplary parameters of a vase, according to some embodiments of the present invention.

The exemplary vase comprises four coaxial components; an ellipsoid part with circular horizontal cuts in the center, a cone with an opening at the top, and a cone, connected to a circular base at the bottom. Exemplary parameters may comprise radiuses at the top opening T, at the center A of the cone connected to the base G and of the base L. Additional parameters comprise the second radius of the ellipsoid part B, and the heights of the meeting points between the ellipsoid part and the cones S and F. There are relations between these parameters which give rise to constraints, for example S F have to be smaller than B, and G smaller than L. There are also dependencies regarding the inclination angles φ_{S}, α_{S}, φ_{F} and α_{F}. Furthermore, constraints may be derived from durability, manufacturing equipment limitations, and/or the likes.

Reference is also made to FIG. 9B which depicts some exemplary drawings for rendered vase designs, generated according to parameters set by a system for automatic product design, according to some embodiments of the present invention. The exemplary vases a, b, c and d are of the design describe in FIG. 9A, with different parameters. For example, the parameter B of examples a and c is higher than it is of the examples b and d.

FIG. 10 is a pseudocode for an exemplary computer implemented algorithm for parametric optimum finding, according to some embodiments of the present invention. The pseudocode is an example in which the constraint shape is used to limit the search space of the optimal solution. The pseudocode example refers to a two dimensional optimization with a fixed square area constraint, however it is apparent to those skilled in the art that a similar pseudocode may work for other shapes or sets thereof. Optionally, the data structure may be a higher dimension tensor or a graph, and the constraints may have for example the shape of a hypercube. Modification to accommodate shapes such as parallelogram may be straightforward, however using such constraints for every fixed shape or set thereof may benefit from the reduction of the complexity to the number of dimensions.

The pseudocode begins with the initialization, and continue with the calculating incremental cumulative sums, and searching for the maximum of the cumulative sum, corresponding to 440 and 540 as described in FIG. 4's and FIG. 5's description.

Later, the exemplary list of maximums, is generated. Alternatively, a list within a tolerance from the maximum may be generated, and non-maximum suppression may be applied. The list of maximums may be sorted and the first few maximums may be allocated according to the number of allocations to provide, corresponding to 450 and 550 as described in FIG. 4's and FIG. 5's description.

It is expected that during the life of a patent maturing from this application many relevant computation and optimization methods, as well as communication, display methods and/or the likes will be developed and the scope of the terms such as image or display, manufacturing, interface, communication, and optimization are intended to include all such new technologies a priori.

The terms “comprises”, “comprising”, “includes”, “including”, “having” and their conjugates mean “including but not limited to”.

The term “consisting of” means “including and limited to”.

The term “multi” means more than one.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for producing parameters for product design, the system comprising:
at least one memory storing at least one preference data structure and a code; and
a processor adapted to execute the code for:
receiving a plurality of preferences parameters of a plurality of customers;
receiving at least one constraint from at least one provider;
mapping at least one preference parameter from the plurality of preferences parameters of the plurality of customers to the preference data structure, wherein at least one dimension of the preference data structure is associated with at least one of the parameters for product design, and elements are associated with at least one of the preferences parameters associated with the at least one of the parameters for product design;
mapping the at least one constraint to a geometric constraint derived from a geometry defined by the preference data structure geometry;
finding at least one optimum based on elements in accordance with the geometric constraint on the preference data structure, wherein the space searched for the at least one optimum is limited according to the geometric constraint; and
producing at least one parameter for product designs in accordance with the at least one optimum.

2. The system of claim 1, wherein finding at least one optimum comprises calculating at least a partial cumulative sum data structure of elements of the preference data structure.

3. The system of claim 1, wherein at least one of the parameters for product design is associated with a geometrical location, and at least one geometric constraint is of length in at least one of the dimensions of the preference data structure, the dimension associated with geometrical distance.

4. The system of claim 1, wherein at least one of the parameters for product design is associated with a physical property of a physical object, and at least one geometric constraint in at least one of the dimensions of the preference data structure, the dimension associated with manufacturability constraints.

5. The system of claim 1, further comprising:
generating a plurality of parameter sets for product designs; and
rendering a plurality of images of a plurality of product in associative accordance with the plurality of parameter sets.

6. The system of claim 5, further comprising receiving a preference score from at least one customer associated with at least one of the plurality of images.

7. The system of claim 6, further comprising updating at least one entry value in the preference data structure according to the received preference score.

8. The system of claim 1, wherein at least one of the parameters for product design is derived from factorization of products associated with the parameters for product design.

9. The system of claim 1, wherein at least one of the plurality of customers is selected by a recommender system, wherein at least one parameter associated with the at least one of the plurality of customers, meets a matching criteria associated with the preference data structure.

10. The system of claim 1, wherein at least one of the plurality of preferences parameters is associated with a collaborative filtering system, wherein at least one parameter associated with the at least one of the plurality of customers, meets a matching criteria associated with the preference data structure.

11. The system of claim 1, wherein at least one of the plurality of preferences parameters from a plurality of customer is associated with a clustering method, wherein at least one parameter for product designs is associated with at least one of the clustering method axes.

12. The system of claim 1, wherein the preference data structure is mapped to a tensor.

13. The system of claim 1, wherein the preference data structure is mapped to a k-d tree.

14. A computer implemented method for producing a product design comprising:
receiving a plurality of preferences parameters of a plurality of customers;
receiving at least one constraint from at least one provider;
mapping at least one preference parameter from the plurality of preferences parameters of the plurality of customers to the preference data structure, wherein at least one dimension of the preference data structure is associated with at least one of the parameters for product design;
mapping the at least one constraint to a geometric constraint derived from a geometry defined by the preference data structure geometry;
finding at least one optimum in accordance with the geometric constraint on the preference data structure, wherein the space searched for the at least one optimum is limited according to the geometric constraint; and
producing at least one parameter for product designs in accordance with the at least one optimum.

15. A computer readable medium storing program instructions for producing a product design comprising:
receiving a plurality of preferences parameters of a plurality of customers;
receiving at least one constraint from at least one provider;
mapping at least one preference parameter from the plurality of preferences parameters of the plurality of customers to the preference data structure, wherein at least one dimension of the preference data structure is associated with at least one of the parameters for product design;
mapping the at least one constraint to a geometric constraint derived from a geometry defined by the preference data structure geometry;
finding at least one optimum in accordance with the geometric constraint on the preference data structure, wherein the space searched for the at least one optimum is limited according to the geometric constraint; and
producing at least one parameter for product designs in accordance with the at least one optimum.
